(19) United States
(12) Patent Application Publication
(10) Pub. No.: US 2022/0156963 A1
(43) Pub. Date: May 19, 2022

(54) COORDINATE SYSTEM CONVERSION PARAMETER ESTIMATING APPARATUS, METHOD AND PROGRAM

(71) Applicant: NIPPON TELEGRAPH AND TELEPHONE CORPORATION, Tokyo (JP)

(72) Inventors: Kosuke TAKAHASHI, Tokyo (JP); Dan MIKAMI, Tokyo (JP); Mariko ISOGAWA, Tokyo (JP); Yoshinori KUSACHI, Tokyo (JP)

(73) Assignee: NIPPON TELEGRAPH AND TELEPHONE CORPORATION, Tokyo (JP)

(21) Appl. No.: 17/435,759

(22) PCT Filed: Feb. 25, 2020
(86) PCT No.: PCT/JP2020/007288

§ 371 Date: Sep. 2, 2021

(30) Foreign Application Priority Data
Mar. 7, 2019 (JP) 2019-041629

(51) Int. Cl. G06T 7/73

(52) U.S. Cl. CPC G06T 7/73; G06T 2207/30196; G06T 2207/30204; G06T 2207/10016

(57) ABSTRACT

A technology for obtaining a coordinate system conversion parameter more easily than in the related art is provided. A coordinate system conversion parameter estimation device includes: a camera coordinate system correspondence point estimation unit 2 configured to estimate 3-dimensional positions of a joint of a moving body in a camera coordinate system from a camera video in which an aspect indicating that the moving body is moving a marker of which 3-dimensional positions in a sensor coordinate system are able to be acquired by a sensor is shown and to set the 3-dimensional positions as 3-dimensional positions of a correspondence point in the camera coordinate system; a sensor coordinate system correspondence point estimation unit 4 configured to estimate a predetermined point of a figure drawn by all or a part of a 3-dimensional position series of the marker from the 3-dimensional position series of the marker corresponding to the camera video and to set the predetermined point as a 3-dimensional position of the correspondence point in the sensor coordinate system; and a coordinate system conversion parameter estimation unit 5 configured to estimate a coordinate system conversion parameter between the camera coordinate system and the sensor coordinate system from the 3-dimensional positions of the correspondence point in the camera coordinate system and the 3-dimensional positions of the correspondence point in the sensor coordinate system.

### TECHNICAL FIELD

The present invention relates to a technology for estimating coordinate system conversion parameters for converting between two different coordinate systems.

### BACKGROUND ART

As devices for acquiring information regarding spaces, various sensors such as IR sensors, time-of-flight (ToF) sensors, and laser range finders are used in addition to cameras. When such a camera and a sensor are used in combination, it is important to align the coordinate systems of the camera and the sensor, in other words, to obtain conversion parameters between the coordinate systems.

For example, as illustrated in FIG. 5, a case in which a user who is a moving body experiencing virtual reality (hereinafter referred to as VR) is performing an interaction with a ball which is a virtual object in a VR space will be presumed. It is assumed that there are two types of sensors (a camera and an IR sensor) in the space.

The camera acquires 3-dimensional positions of each joint of the user in a camera coordinate system (=a real word coordinate system) and the IR sensor acquires 3-dimensional positions of a head-mounted display (hereinafter referred to as an HMD) which the user wears to experience VR or an accessary controller (hereinafter referred to as a marker) in a sensor coordinate system (=a virtual world coordinate system).

It is assumed that the sensor coordinate system matches a coordinate system of a virtual space in which a virtual object is displayed and external calibration is completed.

At this time, even when the user tries to operate the virtual object in a state in which the positions of the camera coordinate system and the sensor coordinate system are not aligned, positions of hands of the user are not measured by the IR sensor and 3-dimensional positions of the hands in the camera coordinate system cannot be converted into the sensor coordinate system. Therefore, the positions of the hands of the user in the virtual space are uncertain and a smooth interaction cannot be performed.

To align the coordinate systems of such different types of sensors, information such as 3-dimensional positions or 2-dimensional projection positions of common points (such positions are referred to hereinafter as correspondence points) in the respective coordinate systems is generally used.

However, when the information acquired by the sensors is different, it is difficult to obtain the 3-dimensional positions or the 2-dimensional projection positions of such common points.

In commercially available VR devices, 3-dimensional positions of markers can be acquired by IR sensors or the like. However, since it is not known from the appearance which positions of the markers are output, it is difficult to associate with a camera video.

In NPL 1, an additional device such as a chessboard is introduced. While such an approach enables stable estimation, an additional device is necessary and thus ordinary easy use is difficult.

### CITATION LIST

### Non Patent Literature

[NPL 1] Raposo, Carolina, Joao Pedro Barreto, and Urbano Nunes, “Fast and accurate calibration of a kinect sensor”, 2013 International Conference on 3D Vision (3DV) IEEE, 2013.

### SUMMARY OF THE INVENTION

### Technical Problem

An objective of the present invention is to provide a coordinate system conversion parameter estimation device, method, and program capable of obtaining coordinate system conversion parameters more easily than in the conventional art.

### Means for Solving the Problem

According to an aspect of the present invention, a coordinate system conversion parameter estimation device includes: a camera coordinate system correspondence point estimation unit configured to estimate 3-dimensional positions of a joint of a moving body in a camera coordinate system from a camera video in which an aspect indicating that the moving body is moving a marker of which 3-dimensional positions in a sensor coordinate system are able to be acquired by a sensor is shown and to set the 3-dimensional positions as 3-dimensional positions of a correspondence point in the camera coordinate system; a sensor coordinate system correspondence point estimation unit configured to estimate a predetermined point of a figure drawn by all or a part of a 3-dimensional position series of the marker from the 3-dimensional position series of the marker corresponding to the camera video and to set the predetermined point as a 3-dimensional position of the correspondence point in the sensor coordinate system; and a coordinate system conversion parameter estimation unit configured to estimate a coordinate system conversion parameter between the camera coordinate system and the sensor coordinate system from the 3-dimensional positions of the correspondence point in the camera coordinate system and the 3-dimensional positions of the correspondence point in the sensor coordinate system.

### Effects of the Invention

By using 3-dimensional positions of correspondence points in the camera coordinate system and 3-dimensional positions of correspondence points in the sensor coordinate system, it is possible to obtain coordinate system conversion parameters of the camera coordinate system and the sensor coordinate system more easily than in the conventional art.

### BRIEF DESCRIPTION OF DRAWINGS

FIG. 1 is a block diagram illustrating an example of a coordinate system conversion parameter estimation device.

FIG. 2 is a block diagram illustrating an example of a sensor coordinate system correspondence point estimation unit 4.

FIG. 3 is a flowchart illustrating an example of a processing procedure of a coordinate system conversion parameter estimation method.

FIG. 4 is a flowchart illustrating an example of a process of a sensor coordinate system correspondence point estimation unit.

FIG. 5 is a diagram illustrating a situation in which a user is performing an interaction with a ball which is a virtual object in a VR space.

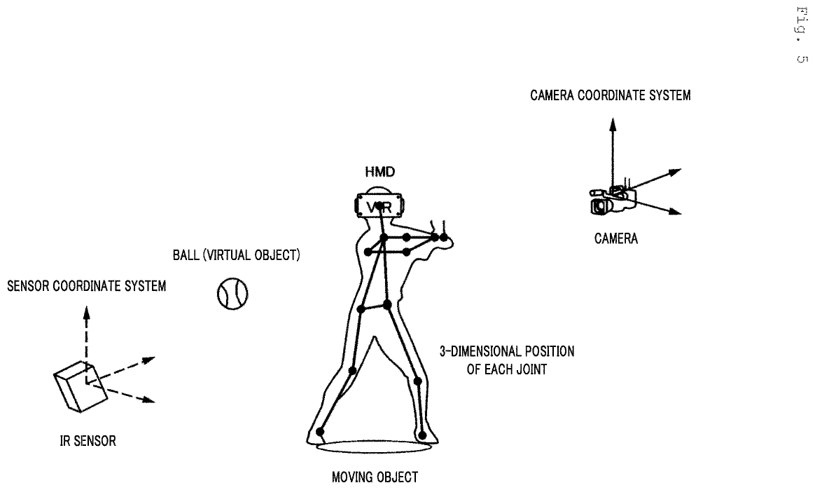

FIG. 6 is a diagram illustrating an example of a specific operation.

FIG. 7 is a diagram illustrating an example of a specific operation.

FIG. 8 is a diagram illustrating an example of a process of the sensor coordinate system correspondence point estimation unit 4.

FIG. 9 is a diagram illustrating a process of a modification example of the sensor coordinate system correspondence point estimation unit 4.

### DESCRIPTION OF EMBODIMENTS

Hereinafter, an embodiment of the present invention will be described in detail. The same reference numerals are given to constituent units that have the same functions in the drawings and repeated description thereof will be omitted.

### Embodiment

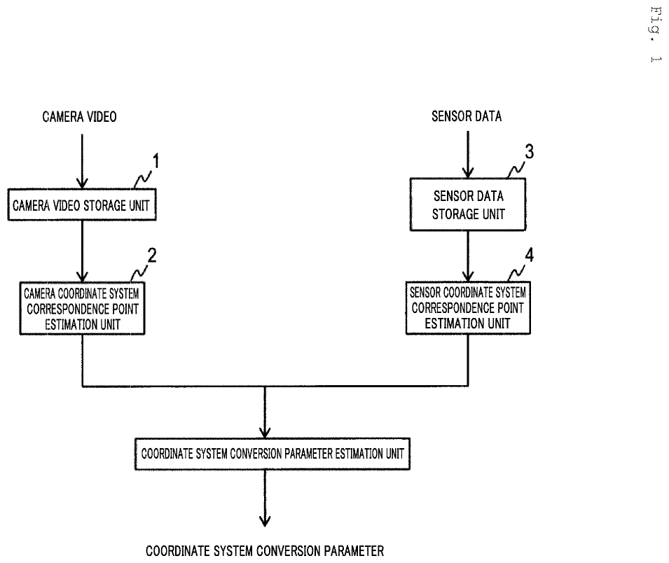

FIG. 1 is a block diagram illustrating an example of a coordinate system conversion parameter estimation device.

The coordinate system conversion parameter estimation device accepts a camera video captured by Nc (≥1) cameras and 3-dimensional positions of a marker acquired by Ns (≥1) sensors as an input and outputs coordinate system conversion parameters of a camera coordinate system and a sensor coordinate system.

The coordinate system conversion parameter estimation device includes, for example, a camera video storage unit 1, a camera coordinate system correspondence point estimation unit 2, a sensor data storage unit 3, a sensor coordinate system correspondence point estimation unit 4, and a coordinate system conversion parameter estimation unit 5. Here, the camera video storage unit 1 stores the input camera video. The camera coordinate system correspondence point estimation unit 2 obtains 3-dimensional positions of correspondence points in the camera coordinate system from the input camera video. The sensor data storage unit 3 stores a 3-dimensional position series of a marker acquired by the sensors. The sensor coordinate system correspondence point estimation unit 4 obtains 3-dimensional positions of correspondence points in the sensor coordinate system from the 3-dimensional position series of the marker. The coordinate system conversion parameter estimation unit 5 estimates inter-coordinate-system conversion parameters from the 3-dimensional positions of the correspondence points estimated in each coordinate system.

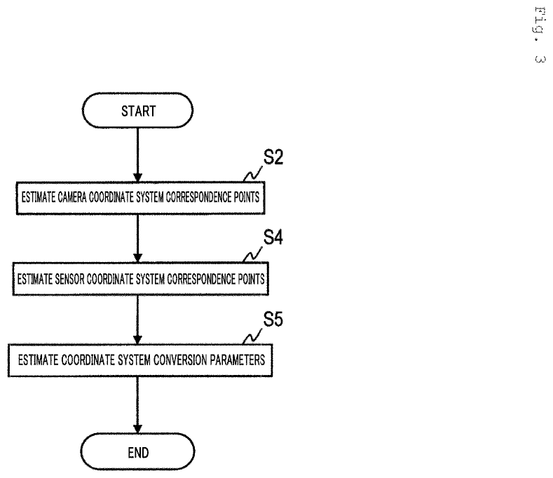

A coordinate system conversion parameter estimation method is realized, for example, by causing each unit to perform at least processes of steps S2, S4, and S5 illustrated in FIG. 3 and the subsequent drawings.

Hereinafter, these units will be described in detail.

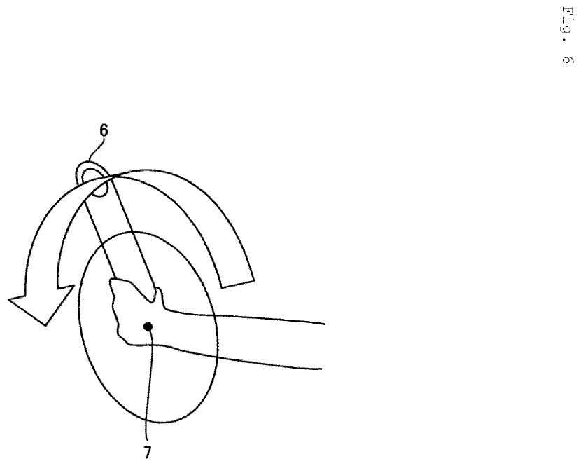

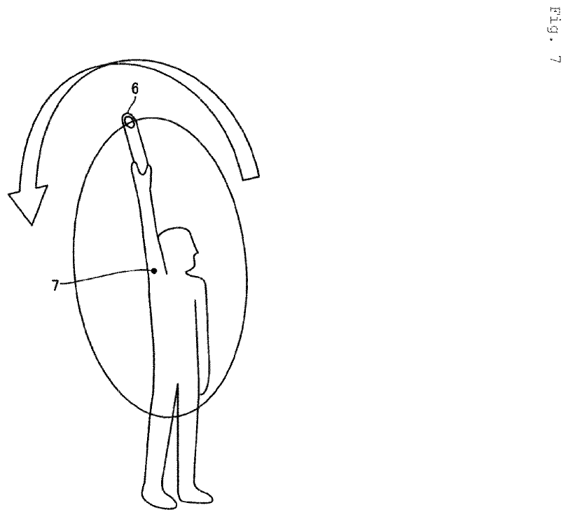

A camera video and a 3-dimensional position series of a marker given as an input are assumed to be obtained when a moving body is performing a specific motion illustrated in FIG. 6 or 7.

The moving body has joints and thus can move the marker through the joints. The moving body is, for example, a human being or a robot that has joints. Hereinafter, the case in which the moving body is a human being will be described as an example.

The specific motion may be any motion as long as a relation of “a center of a figure formed by a trajectory of a marker=any joint position of the moving body” can be satisfied. Figures which is likely to satisfy this relation are, for example, an ellipse (including a perfect circle), a straight line, and a polygon.

An example of the specific motion is a motion of holding the marker 6 with a hand and turning it around a wrist, as illustrated in FIG. 6 or a motion of swinging the marker 6 using a shoulder as the origin point, as illustrated in FIG. 7.

When the motion of holding the marker 6 with the hand and turning it around the wrist is performed, positions of the wrist are positions of the correspondence point 7. When the motion of swinging the marker 6 using the shoulder as the origin point is performed, a position of the shoulder is a position of the correspondence point 7.

The joint positions are preferably fixed while the marker draws the trajectory. In the camera video, the entire human body may not necessarily be shown and at least a joint used as a correspondence point may be shown. The 3-dimensional position series of the marker is assumed to include 3-dimensional positions in which a minimum number of points necessary to detect a figure in a motion performed once (two or more points in the case of a straight line or five or more points in the case of an ellipse) is different.

A camera video and a 3-dimensional position series of the marker corresponding to at least one kind of specific motion performed by a moving body are output to the camera video storage unit 1 and the sensor data storage unit 3, respectively. Here, at least one kind of specific motion is, for example, three or more kinds of specific motions in which correspondence points corresponding to each motion are different.

Any sensor can be used as long as the sensor can acquire 3-dimensional positions of the marker designated in the sensor coordinate system. For example, an IR sensor, a ToF sensor, a laser range finder, or the like can be used.

[Camera Video Storage Unit 1]

A camera video corresponding to at least one kind of specific motion performed by the moving body is input and stored in the camera video storage unit 1.

The camera video storage unit 1 is included in, for example, the coordinate system conversion parameter estimation device. The camera video storage unit 1 is, for example, an HDD when offline processing is assumed. The camera video storage unit 1 is a memory when online processing is performed.

On the other hand, the camera video storage unit 1 may be provided outside of the coordinate system conversion parameter estimation device. For example, the camera video storage unit 1 may be a cloud server connected to the coordinate system conversion parameter estimation device via a network.

It is assumed that the camera video is associated with the 3-dimensional position series of the marker stored in the sensor data storage unit 3 to be described below and is assumed to be synchronized therewith. Here, “associated with” means that information corresponding to a certain scene is assigned to a camera video corresponding to the certain scene and 3-dimensional positions of the marker sensing the same scene as the certain scene.

For example, information regarding a scene S is included in a file name of a camera video corresponding to the scene S and a file name of the 3-dimensional position system of the marker.

[Camera Coordinate System Correspondence Point Estimation Unit 2]

A camera video read from the camera video storage unit 1 is input to the camera coordinate system correspondence point estimation unit 2.

The camera coordinate system correspondence point estimation unit 2 analyzes the moving body shown in the input camera video and estimates 3-dimensional positions of a correspondence point.

The estimated 3-dimensional positions of the correspondence point in the camera coordinate system are output to the coordinate system conversion parameter estimation unit 5.

Specifically, the camera coordinate system correspondence point estimation unit 2 estimates 3-dimensional positions of each joint of the moving body in the camera video, in particular, a joint serving as a correspondence point. A method of estimating the 3-dimensional positions may be any method.

When the camera video is captured by one camera, a method of estimating 3-dimensional joint positions from a single-lens video can be used, for example, as proposed in Reference Literature 1. The details of this method refer to Reference Literature 1.

[NPL 2] Tome, Denis, Christopher Russell, and Lourdes Agapito, “Lifting from the deep: Convolutional 3d pose estimation from a single image”, CVPR 2017 Proceedings (2017): 2500-2509.

When the camera video is captured by two or more cameras and a positional relation between the cameras is known in advance using the technology of Reference Literature 2 or the like, 3-dimensional positions can be estimated by using 2-dimensional positions of each joint estimated with the technology of Reference Literature 3 by the principle of triangulation.

When the camera video is captured by two or more cameras and a positional relation between the cameras is unknown, as proposed in Reference Literature 4, the positional relation can be estimated and synchronized and 3-dimensional positions of the joint can be obtained using the 2-dimensional positions of each joint of a moving body.

The details of the technology can be found in Reference Literature 3 to Reference Literature 5.

[Reference Literature 3] Zhang, Zhengyou, “A flexible new technique for camera calibration”, IEEE Transactions on pattern analysis and machine intelligence 22 (2000).

[Reference Literature 4] Cao, Zhe, et al, “Realtime multi-person 2d pose estimation using part affinity fields”, arXiv preprint arXiv:1611.08050 (2016).

[Reference Literature 5] Takahashi, Kosuke, et al, “Human Pose as Calibration Pattern: 3D Human Pose Estimation with Multiple Unsynchronized and Uncalibrated Cameras”, 2018 IEEE/CVF Conference on Computer Vision and Pattern Recognition Workshops (CVPRW). IEEE, 2018.

In this way, the camera coordinate system correspondence point estimation unit 2 estimates the 3-dimensional positions of the joint of the moving object in the camera coordinate system and sets the 3-dimensional positions as the 3-dimensional positions of the correspondence point in the camera coordinate system (step S2). Here, the camera coordinate system correspondence point estimation unit 2 performs the estimation from the camera video in which an aspect indicating that the moving body is operating the marker of which 3-dimensional positions in the sensor coordinate system are able to be acquired by the sensor is shown.

[Sensor Data Storage Unit 3]

A 3-dimensional position series of the marker corresponding to at least one kind of specific motion performed by the moving body is input and stored in the sensor data storage unit 3.

The sensor data storage unit 3 is included in, for example, the coordinate system conversion parameter estimation device. The camera video storage unit 1 is, for example, an HDD when offline processing is assumed. The sensor data storage unit 3 is a memory when online processing is performed.

On the other hand, the sensor data storage unit 3 may be provided outside of the coordinate system conversion parameter estimation device. For example, the sensor data storage unit 3 may be a cloud server connected to the coordinate system conversion parameter estimation device via a network.

[Sensor Coordinate System Correspondence Point Estimation Unit 4]

The 3-dimensional position series of the marker read from the sensor data storage unit 3 is input to the sensor coordinate system correspondence point estimation unit 4.

The sensor coordinate system correspondence point estimation unit 4 estimates 3-dimensional positions of the correspondence point in the sensor coordinate system from the 3-dimensional position series of the marker. More specifically, the sensor coordinate system correspondence point estimation unit 4 estimates a center of a figure drawn by all or a part of a 3-dimensional position series of the marker from the 3-dimensional position series of the marker corresponding to the camera video and sets the predetermined point as the 3-dimensional position of the correspondence point in the sensor coordinate system (step S4).

The estimated 3-dimensional positions of the correspondence point in the sensor coordinate system are output to the coordinate system conversion parameter estimation unit 5.

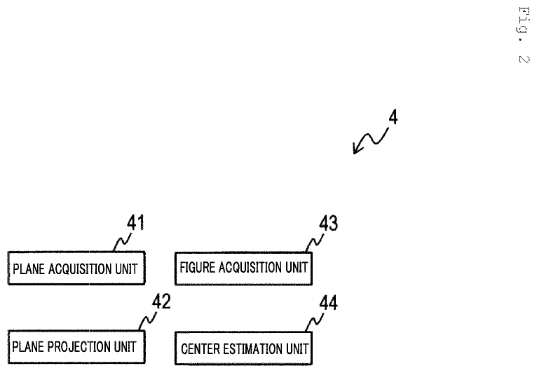

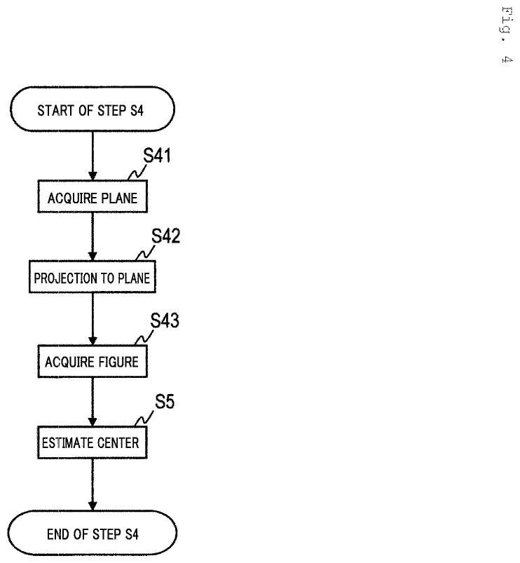

The sensor coordinate system correspondence point estimation unit 4 includes, for example, a plane acquisition unit 41, a plane projection unit 42, a figure acquisition unit 43, and a center estimation unit 44, as illustrated in FIG. 2. These units perform processes of steps S41 to S44 illustrated in FIG. 4 and the subsequent drawings. Hereinafter, these units will be described in detail.

[[Plane Acquisition Unit 41]]

First, the plane acquisition unit 41 of the sensor coordinate system correspondence point estimation unit 4 performs a plane fitting process on the input 3-dimensional position series of the marker (step S41).

At this time, any plane fitting algorithm may be used. A plane equation is expressed as, for example, ax+by+cz+d=0 and there are unknown four quantities (a, b, c, and d). Therefore, each unknown quantity can be obtained using 3-dimensional positional information of four or more points by the least squares method or RANSAC.

In this way, the plane acquisition unit 41 of the sensor coordinate system correspondence point estimation unit 4 obtains a plane formed by the 3-dimensional position series of the marker (step S41). The plane is a plane that approximates the plane formed by the 3-dimensional position series of the marker. Hereinafter, the plane is referred to as an approximate plane. Information regarding the obtained plane is output to the plane projection unit 42.

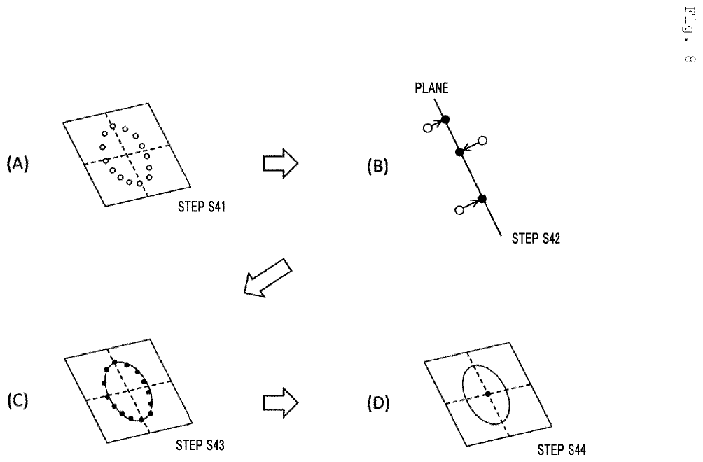

FIG. 8(A) is a diagram illustrating an example of a process of the plane acquisition unit 41. As exemplified in FIG. 8(A), a plane fitted to the 3-dimensional position series is obtained by the plane acquisition unit 41.

[[Plane Projection Unit 42]]

The plane projection unit 42 of the sensor coordinate system correspondence point estimation unit 4 accepts the plane obtained by the plane acquisition unit 41 as an input and projects each point of the 3-dimensional position series of the marker to the input plane. The projecting mentioned here involves dropping a perpendicular to the plane obtained by the plane acquisition unit 41 from each 3-dimensional point and setting intersections of the perpendiculars and the plane as a new 3-dimensional point series, as illustrated in FIG. 8(B). Hereinafter, the new 3-dimensional point series is referred to as a projection point series. Through this process, it is guaranteed that the projection point series is precisely on the same plane.

In this way, the plane projection unit 42 obtains the projection point series obtained by projecting the 3-dimensional position series of the marker to the plane (step S42). The obtained projection point series is output to the figure acquisition unit 43.

FIG. 8(B) is a diagram illustrating an example of a process by the plane projection unit 42. In FIG. 8(B), the projection point series is indicated by points colored in black.

[[Figure Acquisition Unit 43]]

The figure acquisition unit 43 of the sensor coordinate system correspondence point estimation unit 4 obtains a figure formed by the input projection point series (step S43). Information regarding the obtained figure is output to the center estimation unit 44.

For example, when the figure formed by the projection point series is assumed to be an ellipse, the figure acquisition unit 43 performs ellipse fitting on the projection point series. At this time, the ellipse fitting may be any method. For example, the ellipse fitting on the plane can be performed with reference to Reference Literature 6.

Reference Literature 6 can be applied to a 2-dimensional plane. Therefore, it is necessary to express the projection point series as 2-dimensional coordinate values at one time. Here, it is guaranteed that the projection point series is precisely on the same plane. Therefore, the figure acquisition unit 43 decides a 2-dimensional coordinate system in which any point on the plane is the origin, obtains the 2-dimensional coordinate values of the projection point series in the 2-dimensional coordinate system, and performs the ellipse fitting on the 2-dimensional coordinate values.

FIG. 8(C) is a diagram illustrating an example of a process of the figure acquisition unit 43. As exemplified in FIG. 8(C), an ellipse fitted to the projection point series is obtained by the figure acquisition unit 43.

[[Center Estimation Unit 44]]

The center estimation unit 44 of the sensor coordinate system correspondence point estimation unit 4 accepts information regarding the figure obtained by the figure acquisition unit 43 as an input and estimates a center of the figure (step S44). The estimated center of the figure is considered as a 3-dimensional position of the correspondence point in the sensor coordinate system. The estimated 3-dimensional position of the correspondence point in the sensor coordinate system is output to the coordinate system conversion parameter estimation unit 5.

Hereinafter, for example, the following exemplified point is assumed to be indicated in each figure as the center. When the figure is a circle, the center is a point which is on the same plane as the circle and is a point equidistant from any point on a circumference of the plane. When the figure is an ellipse, the center is an intersection of the major axis and the minor axis of the ellipse. When the figure is a straight line, the center is a point bisecting the straight line. When the figure is a polygon, the predetermined point is a center of gravity. For example, when the figure formed by the projection point series is assumed to be an ellipse, the center estimation unit 44 obtains an intersection of the major axis and the minor axis of the ellipse obtained by the figure acquisition unit 43 as a central position. Then, the center estimation unit 44 outputs coordinate values of the central position as coordinate values of the correspondence point in the sensor coordinate system.

A scheme of obtaining the central position of the ellipse may be any method. For example, in the scheme of Reference Literature 6, since information regarding the central position, a longer diameter, a shorter diameter, and a slope of the ellipse at the time of fitting can be obtained, the information may be used. The figure formed by the projection point series may not be an ellipse. Even when a certain kind of figure is drawn, a minimum ellipse which can contain an entire drawn trajectory of the marker may be estimated and coordinate values of the central position of the ellipse may be set as coordinate values of the correspondence point in the sensor coordinate system. When fitting is performed as in Reference Literature 6, as described in the figure acquisition unit 43, the coordinate values of the central position are returned from the 2-dimensional coordinate system to the sensor coordinate system.

[Reference Literature 6] Fitzgibbon, Andrew, Maurizio Pilu, and Robert B. Fisher, “Direct least square fitting of ellipses”, IEEE Transactions on pattern analysis and machine intelligence 21.5 (1999): 476-480.

FIG. 8(D) is a diagram illustrating an example of a process of the center estimation unit 44. As exemplified in FIG. 8(D), the center of the ellipse is obtained by the center estimation unit 44.

[Coordinate System Conversion Parameter Estimation Unit 5]

The 3-dimensional position of the correspondence point in the camera coordinate system estimated by the camera coordinate system correspondence point estimation unit 2 and the 3-dimensional position of the correspondence point in the sensor coordinate system estimated by the sensor coordinate system correspondence point estimation unit 4 are input to the coordinate system conversion parameter estimation unit 5.

The coordinate system conversion parameter estimation unit 5 estimates coordinate system conversion parameters from the 3-dimensional position of the correspondence point in the camera coordinate system and the 3-dimensional position of the correspondence point in the sensor coordinate system (step S5). A scheme of obtaining the coordinate system conversion parameters may be any scheme.

For example, three or more pairs of 3-dimensional positions of the correspondence points in the camera coordinate system and 3-dimensional positions of the correspondence points in the sensor coordinate system are input to the coordinate system conversion parameter estimation unit 5.

In this case, the coordinate system conversion parameter estimation unit 5 obtains 3×3 rotation matrix coordinate system conversion parameters and coordinate system conversion parameters formed by 3×1 translation vectors using the pairs.

For example, it is possible to use a scheme of obtaining the coordinate system conversion parameters by obtaining absolute orientation from the pairs (for example, see Reference Literature 7).

[Reference Literature 7] Horn, Berthold K P, “Closed-form solution of absolute orientation using unit quaternions”, JOSA A 4.4 (1987): 629-642.

In this way, the coordinate system conversion parameter estimation unit 5 creates a common correspondence point using a positional relation generated when a person wearing the marker is performing a specific motion. Here, the correspondence point is created so that the center of the figure formed by a trajectory of the 3-dimensional position of the marker matches the 3-dimensional position of a joint. Thus, it is possible to obtain the coordinate system conversion parameters more easily than in the conventional art.

### MODIFICATION EXAMPLES

When a figure drawn by a part of the 3-dimensional position series of the marker is a line segment or a polygon, for example, the sensor coordinate system correspondence point estimation unit 4 may estimate 3-dimensional positions of the correspondence point in the sensor coordinate system, for example, as follows.

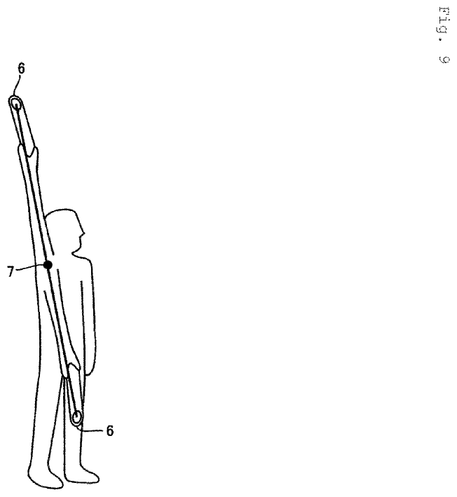

For example, when a figure formed by a trajectory of the marker is estimated to be a line segment, for example, the sensor coordinate system correspondence point estimation unit 4 may estimate 3-dimensional positions of the correspondence point in the sensor coordinate system as follows. An example of a specific motion in this case is, for example, a motion of stopping the marker 6 at positions forming an angle of 180 degrees with each position centered on a shoulder exemplified in FIG. 9 for several seconds.

The sensor coordinate system correspondence point estimation unit 4 first obtains a point at which a position is not changed for a fixed time in the 3-dimensional position series of the marker obtained as an input. The fixed time is a pre-decided time, and may be about, for example, 1 to 2 seconds, or may be a longer time.

An example of the point at which the position is not changed for the fixed time is an average of the positions of the 3-dimensional position series within the fixed time when a total amount of the change in the position moved within the fixed time is equal to or less than a pre-decided threshold. Another example of the point at which the position is not changed for the fixed time is an average of positions of the 3-dimensional position series within the fixed time when a movement speed of points forming the 3-dimensional position series within the fixed time is equal to or less than a pre-decided threshold.

The sensor coordinate system correspondence point estimation unit 4 estimates a central point of a line segment connecting points at which the obtained position is not changed for the fixed time as the 3-dimensional position of the correspondence point in the sensor coordinate system.

For example, when the figure formed by the trajectory of the marker is assumed to be a polygon, for example, the sensor coordinate system correspondence point estimation unit 4 may estimate 3-dimensional positions of the correspondence point in the sensor coordinate system as follows. An example of a specific motion in this case is a motion of stopping the marker for several seconds at positions at which an angle of a degrees from each position centered on the shoulder is formed. Here, b is a predetermined integer equal to or greater than 3 and a is an angle satisfying 360=a*b.

The sensor coordinate system correspondence point estimation unit 4 first obtains three or more points at which positions are not changed for a fixed time in the 3-dimensional position series of the marker obtained as an input as in the case in which the figure formed by the trajectory of the marker is a line segment.

The sensor coordinate system correspondence point estimation unit 4 obtains a central position of a polygon that has three or more points at which the obtained positions are not changed for the fixed time as vertices and has b vertices satisfying 360=a*b, and estimates the 3-dimensional positions of the correspondence point in the sensor coordinate system.

An embodiment of the present invention has been described above, but a specific configuration is not limited to the embodiment. Appropriate changes in the design or the like can be made within the scope of the present invention without departing from the gist of the present invention and are, of course, included in the present invention.

The various processes described in the embodiment are not necessarily performed chronologically in the described order and may also be performed in parallel or individually as necessary or in accordance with a processing ability of a device performing the processes.

For example, data between the constituent units of the coordinate system conversion parameter estimation device may be exchanged directly or may be exchanged via a storage unit (not illustrated).

[Program and Recording Medium]

When various processing functions of the above-described coordinate system conversion parameter estimation device are realized by a computer, processing content of functions which the coordinate system conversion parameter estimation device should have is described in accordance with a program. Various process functions in the coordinate system conversion parameter estimation device are realized on the computer by executing the program on the computer.

The program describing the processing content can be recorded on a computer-readable recording medium. Any computer-readable recording medium, for example, a magnetic recording device, an optical disc, a magnetooptical recording medium, or a semiconductor memory, may be used.

The program is distributed, for example, by selling, transferring, or lending a portable recording medium such as a DVD or a CD-ROM on which the program is recorded. Further, the program may be distributed by storing the program in a storage device of a server computer and transmitting the program from the server computer to another computer via a network.

For example, a computer that executes the program first stores the program recorded on a portable recording medium or the program transmitted from a server computer temporarily on a magnetic storage device. Then, when a process is performed, the computer reads the program stored in the magnetic storage device and performs a process in accordance with the read program. As another execution form of the program, the computer may directly read the program from the portable recording medium and perform a process in accordance with the program and may further perform a process in accordance with the received program in sequence whenever the program is transmitted from the server computer to the computer. The above-described processes may be performed by a so-called application server provider (ASP) type service for realizing the processing functions in accordance with only an execution instruction and result acquisition without performing transmission of the program to the computer from the server computer. The program according to the embodiment is assumed to include data that is information provided for a process by an electronic computing device and conforms to a program (data or the like that has a feature defining a process of a computer rather than a direction instruction for a computer).

In the embodiment, the device is configured by executing a predetermined program on a computer, but at least some of the processing content may be realized by hardware.

### REFERENCE SIGNS LIST

1 Camera video storage unit
2 Camera coordinate system correspondence point estimation unit
3 Sensor data storage unit
4 Sensor coordinate system correspondence point estimation unit
41 Plane acquisition unit
42 Plane projection unit
43 Figure acquisition unit
44 Center estimation unit
5 Coordinate system conversion parameter estimation unit
6 Marker
7 Correspondence point

1. A coordinate system conversion parameter estimation device comprising: processing circuitry configured to estimate 3-dimensional positions of a joint of a moving body in a camera coordinate system from a camera video in which an aspect indicating that the moving body is moving a marker of which 3-dimensional positions in a sensor coordinate system are able to be acquired by a sensor is shown and to set the 3-dimensional positions as 3-dimensional positions of a correspondence point in the camera coordinate system; estimate a predetermined point of a figure drawn by all or a part of a 3-dimensional position series of the marker from the 3-dimensional position series of the marker corresponding to the camera video and to set the predetermined point as a 3-dimensional position of the correspondence point in the sensor coordinate system; and estimate a coordinate system conversion parameter between the camera coordinate system and the sensor coordinate system from the 3-dimensional positions of the correspondence point in the camera coordinate system and the 3-dimensional positions of the correspondence point in the sensor coordinate system.

2. The coordinate system conversion parameter estimation device according to claim 1, wherein the processing circuitry configured to obtain an approximate plane formed by the 3-dimensional position series of the marker, obtain a projection point series obtained by projecting the 3-dimensional position series of the marker to the approximate plane, obtain a figure formed by the projection point series, and estimate a predetermined point of the figure.

3. The coordinate system conversion parameter estimation device according to claim 1, wherein the figure drawn by some of the 3-dimensional position series is a line segment or a polygon.

4. The coordinate system conversion parameter estimation device according to claim 1, wherein the predetermined point is on the same plane as a circle and is a point equidistant from points on a circumference of the plane when the figure drawn by some of the 3-dimensional position series is the circle, the predetermined point is an intersection of a major axis and a minor axis of an ellipse when the figure is the ellipse, the predetermined point is a point bisecting a straight line when the figure is the straight line, and the predetermined point is a center of gravity when the figure is a polygon.

5. A coordinate system conversion parameter estimation method comprising: estimating, by a camera coordinate system correspondence point estimation unit, 3-dimensional positions of a joint of a moving body in a camera coordinate system from a camera video in which an aspect indicating that the moving body is moving a marker of which 3-dimensional positions in a sensor coordinate system are able to be acquired by a sensor is shown and setting the 3-dimensional positions as 3-dimensional positions of a correspondence point in the camera coordinate system; estimating, by a sensor coordinate system correspondence point estimation unit, a predetermined point of a figure drawn by all or a part of a 3-dimensional position series of the marker from the 3-dimensional position series of the marker corresponding to the camera video and setting the predetermined point as a 3-dimensional position of the correspondence point in the sensor coordinate system; and
estimating, by a coordinate system conversion parameter estimation unit, a coordinate system conversion parameter between the camera coordinate system and the sensor coordinate system from the 3-dimensional positions of the correspondence point in the camera coordinate system and the 3-dimensional positions of the correspondence point in the sensor coordinate system.

6. A non-transitory computer readable medium that stores a program causing a computer to perform each step of the coordinate system conversion parameter estimation method according to claim 5.
